(19) United States
(12) Patent Application Publication
(10) Pub. No.: US 2008/0046980 A1
(43) Pub. Date: Feb. 21, 2008

(54) DYNAMIC CONTENT DELIVERY METHOD, PERSONALIZED DYNAMIC CONTENT ENABLER AND DYNAMIC CONTENT DELIVERY SYSTEM

(75) Inventor: Jin PENG, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/837,902

(22) Filed: Aug. 13, 2007

Related U.S. Application Data
(63) Continuation of application No. PCT/CN2006/002460, filed on Sep. 20, 2006.

(30) Foreign Application Priority Data
Dec. 5, 2005 (CN) 200510127538.X

(51) Int. Cl. H04L 9/32

(52) U.S. Cl. 726/4

(57) ABSTRACT

This invention discloses a dynamic content delivery method, an personalized dynamic content enabler and a system. The method includes: generating a personalized processing policy for content subscribed or requested by a user according to user information and content information when delivering the content to the user; and sending the content to a terminal of the user after processing the content by means of the personalized processing policy if the personalized processing policy meets user requirements., which may reduce the cost of obtaining information during the process of personalizing dynamic contents and improve the efficiency of delivering the dynamic contents, thereby improving the service experience of users.

This application is a continuation of International Patent Application No. PCT/CN2006/002460, filed Sep. 20, 2006, which claims priority to Chinese Patent Application No. 200510127538.X, filed Dec. 5, 2005, both of which are hereby incorporated by reference.

### FIELD OF THE INVENTION

The present invention relates to client/selver based dynamic content transmission techniques, and more particularly, to a dynamic content delivery method, a personalized dynamic content enabler, and a dynamic content delivery system.

### BACKGROUND OF THE INVENTION

The dynamic content delivery is based on a client/server structure and used for delivering personalized contents to a mobile terminal user. After the mobile terminal user customizes contents, a server personalizes the contents according to user parameters, user location and online status, and delivers the contents to the mobile terminal user periodically.

Conventional content delivery systems are based on a user-subscription/periodic-delivery mode or a user-request/server-response mode. In the above two modes, the server delivers to a user the contents designated by a user request or user subscription, and the contents are static. However, different users have different requirements, and all users hope that the server can personalize the contents designated by the user request or user subscription according to their respective requirements. In order to improve the user experience, the server should perform different processing for the same contents according to the requirements of different users before delivering the contents, which needs the support of a dynamic content delivery system.

A personalized dynamic content enabler is a core function component of the dynamic content delivery system, and may provide a personalized processing policy for the specific contents to be delivered to a specific user. However, conventional policy processing systems can not perform calculations unless all possible input attribute values are obtained, and thus the method of policy processing is not optimal since the cost of obtaining some input attribute values is high.

### SUMMARY OF THE INVENTION

The present invention provides a dynamic content delivery method, a personalized dynamic content enabler and a dynamic content delivery system.

The dynamic content delivery method includes:

generating a personalized processing policy for content subscribed or requested by a user according to user information and content information when delivering the content to the user; and

sending the content to a terminal of the user after processing the content by means of the personalized processing policy if the personalized processing policy meets user requirements.

The personalized dynamic content enabler includes:

an input module, capable of receiving a dynamic content personalized processing request, obtaining user information and content information according to the dynamic content personalized processing request;

a decision module, capable of generating a personalized processing policy for content subscribed or requested by a user according to the user information and the content information received from the input module.

The dynamic content delivery system includes:

a subscription management module, capable of authenticating a user subscribing to or requesting content, and providing user information;

a dynamic content delivery management module, capable of initiating a personalized processing request, providing the user information and content information necessary for generating a personalized processing policy, receiving a personalized processing policy, personalizing the content according to the personalized processing policy, and delivering the personalized content to a dynamic content delivery client of the user;

the personalized dynamic content enabler is capable of obtaining the user information from the subscription management module or the dynamic content delivery management module, obtaining the content information from the dynamic content delivery management module, generating the personalized processing policy according to the user information and the content information, and sending the personalized processing policy to the dynamic content delivery management module.

As can be seen from the above-mentioned technical scheme, the embodiments of the present invention may reduce the cost of obtaining information during the process of personalizing dynamic contents and improve the efficiency of delivering the dynamic contents, thereby improving user service experience.

### BRIEF DESCRIPTION OF THE DRAWINGS

FIG. 1 is a simplified schematic diagram illustrating the input/output information of a personalized dynamic content enabler in accordance with an embodiment of the present invention.

FIG. 2 is a processing flowchart of a personalized dynamic content enabler in accordance with an embodiment of the present invention.

FIG. 3 is a simplified schematic diagram illustrating the structure of a dynamic content delivery system in accordance with an embodiment of the present invention.

### DETAILED DESCRIPTION OF THE INVENTION

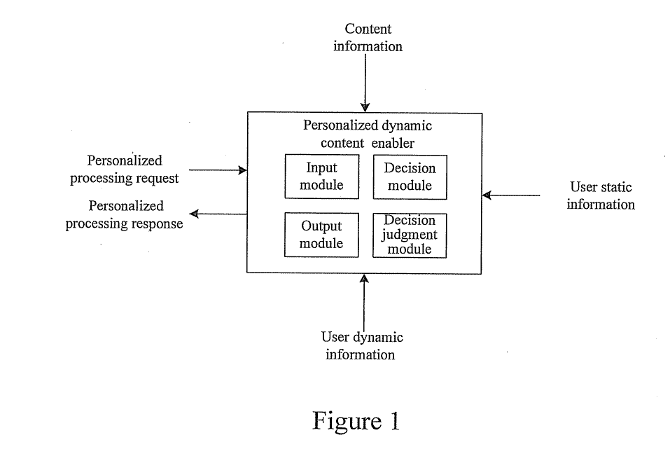

FIG. 1 is a simplified schematic diagram illustrating the input/output information of a personalized dynamic content enabler in accordance with an embodiment of the present invention, which is depicted as follows.

The input information of the personalized dynamic content enabler includes the following contents.

1. A personalized processing request, for requesting personalized processing for certain specific content and a certain specific user, which is initiated by an external entity to the personalized dynamic content enabler. The personalized processing request includes at least one of a content identity and a user identity. If only the user identity is included, the personalized processing request means that all contents of the user corresponding to the user identity need to be personalized before being delivered; if only the content identity is included, the personalized processing request means that the content corresponding to the content identity is personalized for all users who subscribe to or request the content. Optional content included in the personalized processing request indicates what personalized operation instructions should be returned in a personalized response.

2. Content information, including the content identity, content expiration time, a content topic type and content file type information.

3. User static information, including the user identity, user public parameter settings (e.g., age, sex and preference), user subscription information, subscription content delivery schedule, as well as delivery processing policies during roaming and content filtering options during roaming.

4. User dynamic information, including terminal capability information, user location information and presence status information.

The output information of the personalized dynamic content enabler includes:

a personalized operation instruction, which is a decision about how to personalize the content to be delivered. The personalized operation instruction is sent by the personalized dynamic content enabler to the external entity initiating the personalized processing request. The personalized operation instruction includes the file format of the content to be processed and such information corresponding to the file format as screen size, color depth, data rate and the time period needing to be shielded or area needing to be shielded. The personalized operation instruction may be a text, e.g., the eXtensible Markup Language (XML), and the text may be resolved by the external entity initiating the personalized processing request.

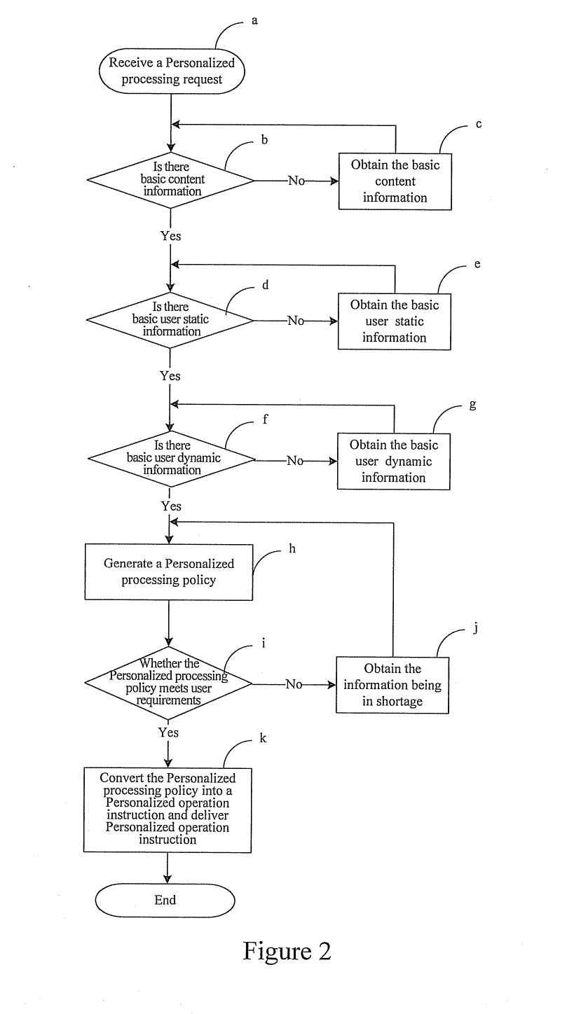

The personalized dynamic content enabler receives the personalized processing request, the content information and the user information. In the embodiments of the present invention, the user information includes the user static information and the user dynamic information. After a personalized processing policy is generated, the personalized dynamic content enabler returns a personalized processing response to the external entity. The processing procedure of the personalized dynamic content enabler is as shown in FIG. 2, which includes the following processes.

Block a: Receiving a dynamic content personalized processing request.

Block b: Querying whether the dynamic content personalized processing request contains enough basic content information necessary for generating a personalized processing policy. If some basic content information is in shortage, proceeding to Block c; otherwise, proceeding to Block d.

Block c: Obtaining the basic content information being in shortage.

Block d: Querying whether the dynamic content personalized processing request contains enough basic user static information necessary for generating a personalized processing policy. If some basic user static information is in shortage, proceeding to Block e; otherwise, proceeding to Block f.

Block e: Obtaining the basic user static information being in shortage.

Block f: Querying whether the dynamic content personalized processing request contains enough basic user dynamic information necessary for generating a personalized processing policy. If some basic user dynamic information is in shortage, proceeding to Block g; otherwise, proceeding to Block h.

Block g: Obtaining the basic user dynamic information being in shortage.

Block h: Generating a personalized processing policy according to the foregoing obtained information; or alternatively processing an existing personalized processing policy according to the foregoing obtained information to generate the personalized processing policy.

Block i: Comparing the generated personalized processing policy with a user request and a judgment condition predetermined in the personalized dynamic content enabler (the judgment condition designates contents which should be included in personalized processing policies of all users); if the personalized processing policy includes all contents of the user request and the judgment condition, proceeding to Block k; otherwise, proceeding to Block j.

Block j: Obtaining information being in shortage, and proceeding to Block h.

Block k: Converting the generated personalized processing policy into a personalized operation instruction and delivering the personalized operation instruction.

In the procedure as shown in FIG. 2, the personalized dynamic content enabler queries whether the basic content information, the basic user static information and the basic user dynamic information exist in a random order.

In accordance with the above procedure, the personalized dynamic content enabler includes an input module, a decision module, a decision judgment module and an output module.

The input module is used for receiving a dynamic content personalized processing request initiated by an external entity, obtaining user information and content information according to the personalized processing request, and sending the user information and the content information to the decision module.

The decision module is used for generating a personalized processing policy for personalizing dynamic content according to the user information and the content information, and sending the personalized processing policy to the decision judgment module. The decision module includes an input judgment sub-module for determining whether the received basic user static information, basic user dynamic information and basic content information meet the requirements of generating the personalized processing policy. If the received basic user static information, basic user dynamic information and basic content information meet the requirements of generating the personalized processing policy, generating the personalized processing policy according to the received user information and content information. Otherwise, informing the input module to obtain basic user static information, basic user dynamic information or basic content information being in shortage.

The decision judgment module is used for deciding whether the personalized processing policy meets user requirements. If the personalized processing policy meets user requirements, the personalized processing policy is sent to the output module. Otherwise, informing the input module to obtain user information or the content information necessary for generating a personalized processing policy meeting the user requirements. In the process of deciding, the decision judgment module is used for comparing the received personalized processing policy with a user request and a judgment condition predetermined in the decision judgment module. If the personalized processing policy includes all contents included in the user request and the judgment condition, the personalized processing policy meets the user requirements, and the decision judgment module sends the personalized processing policy to the output module.

The output module is used for converting the personalized processing policy into a personalized operation instruction and sending the personalized operation instruction to the external entity initiating the personalized processing request.

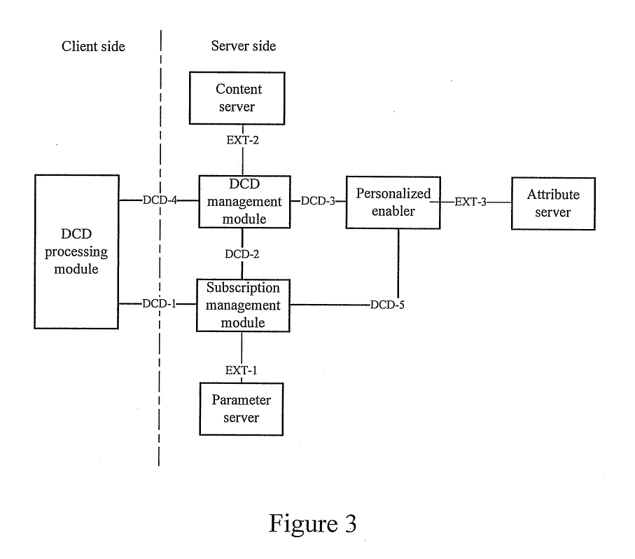

Based on the above personalized dynamic content enabler, the structure of a dynamic content delivery system according to an embodiment of the present invention is as shown in FIG. 3. The dynamic content delivery system includes a client side entity and server side entities. The client side entity is a Dynamic Content Delivery (DCD) client, which may be a user agent in a mobile terminal used for exchanging and delivering contents with the server side entities. The server side entities include a DCD internal logic entity and a DCD external logic entity. The DCD internal logic entity is a part of a DCD server. The DCD external logic entity is not a part of the DCD server, but it interacts with the DCD server to provide information desired by the DCD server. The DCD internal logic entity includes a DCD management module, a subscription management module and a personalized dynamic content enabler at least. The DCD external logic entity may include a parameter server, an attribute server and a content server. The major functions of each module in the dynamic content delivery system are described as follows.

Major functions of the DCD client include, but are not limited to: requesting authentication from the subscription management module, supporting multiple authentication modes, such as an authentication mode based on a communication network (authentication by means of a SIM card) and a direct Client/Server (C/S) authentication mode (authentication by means of a user name and password); interacting with the subscription management module, subscribing on the DCD server, cancelling the subscription of DCD services, and changing subscription content, channel, delivery time and information associated with the subscription; requesting and receiving desired content from the DCD management module; displaying (playing) the content on a terminal device; displaying (playing) the content via binding the content with other application programs in the terminal device.

The DCD management module is a major management module of the DCD server side used for providing the DCD client with a dynamic content delivery service applicable to the DCD client. The major functions of the DCD management module include: requesting and receiving user subscription information from the subscription management module; obtaining original content from an external content server; interacting with the personalized dynamic content enabler to obtain the personalized processing policy associated with the user and the original content; personalizing the original content according to the user requirements to generate a content data packet meeting delivery requirements; and sending the content data packet to the relevant DCD client.

The subscription management module is a module of the DCD server side for managing user subscription and content subscription. The major functions of the subscription management module include: supporting various user authentication modes, which include, but are not limited to, an authentication mode based on a communication network (authentication by means of a SIM card) and a direct Client/Server (C/S) authentication mode (authentication by means of a user name and password); obtaining existing user parameters and user device parameters from an external parameter server; managing setting parameters associated with the DCD of a user, which includes subscription status, subscription content and subscription date of the DCD of the user, specifically, reading, adding, deleting and modifying the setting parameters; providing the DCD management module with the subscription information of the user.

The personalized dynamic content enabler is a module of the DCD server side for providing a personalized processing policy. The personalized dynamic content enabler generates a personalized process policy for a specific user and a specific content according to the user information and the content information desired by the user, obtains existing user setting attributes and dynamic attributes from an external attribute server, and sends to the DCD management module the personalized process policy associated with the specific user and the specific content.

The parameter server is at least one external server for providing the DCD subscription management module with the public parameter settings of the user (e.g., the age of the user) and the terminal capability information of the user.

The attribute server is at least one external server for providing the personalized dynamic content enabler with the dynamic attribute information of the user, such as the current location of the user and the presence status of the user.

The content server is at least one external server for providing original contents which are not processed.

DCD internal logical entities are connected via a DCD internal interface, and a DCD internal logical entity connects with a DCD external logical entity via a DCD external interface. The DCD internal interface and the DCD external interface are hereinafter described in detail.

The DCD internal interface includes:

DCD-1 interface, which is an interface between the DCD client and the subscription management module. The information exchanged via the interface includes, but is not limited to, DCD client authentication information, DCD relevant setting parameters and operation commands for operating the DCD relevant setting parameters.

DCD-2 interface, which is an interface between the DCD management module and the subscription management module. The information exchanged via the interface includes, but is not limited to, user subscription information.

DCD-3 interface, which is an interface between the DCD management module and the personalized dynamic content enabler. The information exchanged via the interface includes, but is not limited to, the user information and the content information provided by the DCD management module to the personalized dynamic content enabler, and personalized processing policy associated with the specific user and the specific content provided by the personalized dynamic content enabler to the DCD management module.

DCD-4 interface, which is an interface between the DCD client and the DCD management module. The information exchanged via the interface includes, but is not limited to, a request for personalized contents sent by the DCD client and the personalized dynamic content delivered by the DCD management module to the DCD client.

DCD-5 interface, which is an interface between the subscription module and the personalized dynamic content enabler. The information exchanged via the interface includes, but is not limited to, a certain user identity sent by the personalized dynamic content enabler to the subscription management module and user information sent by the subscription management module to the personalized dynamic content enabler.

The DCD external interface includes:

EXT-1 interface, which is an external interface between the subscription management module and the parameter server, and supports the interaction of the public parameter settings and the terminal capability information of the user between the parameter server and the subscription management module.

EXT-2 interface, which is an external interface between the DCD management module and the content server, and supports the interaction of original contents between the content server and the DCD management module.

EXT-3 interface, which is an external interface between the personalized dynamic content enabler and the attribute server, and supports the interaction of user dynamic attribute information between the attribute server and the personalized dynamic content enabler.

There are two modes of dynamic content delivery, that is a user-request/server-response mode and a user-subscription/periodic-delivery mode. The user-request/server-response mode includes two circumstances, accepting a user request by the subscription management module of the server side and accepting the user request by the DCD management module. The above two circumstances are respectively described hereinafter with reference to six embodiments and the dynamic content delivery system provided by an embodiment of the present invention.

In one embodiment, a user sends to the subscription management module a user request for some contents on demanded via the DCD client, and the dynamic content delivery procedure specifically includes:

1: The user interacts with the subscription management module via the DCD client to order a movie.

2: The subscription management module authenticates the user.

3: After authenticating the user successfully, the subscription management module obtains basic user static information (e.g., a user identity, age, sex, preference settings and terminal capability information) from the parameter server, obtains the DCD relevant information (e.g., subscription information, subscription content delivery schedule, delivery processing policy and content filtering options during roaming), maintained by the subscription management module, from the subscription management module, and obtains a relevant content identity from the subscription information stored by the subscription management module according to the user request. For example, the terminal capability information includes: the terminal type being LG660, the display capability being 160*128, 290 thousands color and supporting an avi format. The terminal capability information may be static or dynamic, and when the mobile terminal supports “plug and play”, the terminal capability information is dynamic.

4: The subscription management module sends to the DCD management module the basic user static information, the DCD relevant information and the content identity (e.g., a movie file ID).

5: The DCD management module obtains original content (e.g., a movie file) and basic content information (e.g., a movie ID, movie file format, movie type and expiration time information) from the external content server according to the content identity. For example, the basic content information may include: the movie file format being mpeg, the movie type being action and the expiration time being 20051231.

6: The DCD management module initiates to the personalized dynamic content enabler a personalized processing request containing the basic user static information and basic content information to request the personalized dynamic content enabler to generate a personalized processing policy of the content for the user, and may designate operation instructions (e.g., screen size, color depth and time period to be shielded) which must be included in the personalized processing policy.

7: The personalized dynamic content enabler obtains the basic user dynamic information (e.g., location information and presence status information) from an external server. For example, the personalized dynamic content enabler obtains the user location from a location server and obtains the current user status from a Presence Server.

8: The personalized dynamic content enabler generates the personalized processing policy of the content requested by the user. For example, if the current user statues is “on driving”, the content can not be played temporarily; if the age of the user is 13, the content requested by the user will be reduced by the content of 15 minutes 20 seconds to 15 minutes 25 seconds; the content adaptation according to the terminal capability (e.g., supporting an avi file format) and the format of original content (e.g., a mpeg file format) is necessary.

Before the personalized processing policy is generated, if the personalized dynamic content enabler determines that the basic user static information, the basic user dynamic information or the basic content information is in shortage, it obtains the information being in shortage from a relevant module or an external server until meeting the basic requirements necessary for generating the personalized processing policy.

Upon the generation of the personalized processing policy, if the personalized dynamic content enabler determines that the personalized processing policy, which is generated according to the above basic information, can not meet user requirements, the personalized dynamic content enabler obtains other information from a relevant module or an external server, and regenerates a personalized processing policy according to the obtained information until the generated personalized processing policy meets the user requirements. In this process, the personalized dynamic content enabler compares the personalized processing policy with the user request and the predetermined judgment condition; if the personalized processing policy includes all contents of the user request and the judgment condition, it is determined that the personalized processing policy meets the user requirements. For example, the predetermined judgment condition designates that the personalized processing policy must include file format information, and the user request designates that the personalized processing policy must include screen size, color depth and the time period needing to be shielded. If the generated personalized processing policy includes: the file format: avi, the screen size: 160*128, the color depth: 65536, the time period to be shielded: 15 minutes 20 seconds to 15 minutes 25 seconds, the personalized processing policy meets the user requirements. If the generated personalized processing policy includes: the file format: avi, the screen size: 160*128, the time period to be shielded: 15 minutes 20 seconds to 15 minutes 25 seconds (the color depth designated by the user request is not included), or includes: the screen size: 160*128, the time period to be shielded: 15 minutes 20 seconds to 15 minutes 25 seconds (the file format designated by the predetermined judgment condition is not included), the personalized processing policy can not meet the user requirements.

9: The personalized dynamic content enabler converts the personalized processing policy into a personalized operation instruction, and sends it to the DCD management module. The personalized operation instruction includes the file format of the content to be processed at least, and may further include the information corresponding to the file format, such as screen size, color depth, data rate or the time period to be shielded or area.

10: The DCD management module processes the original content of the movie according to the personalized operation instruction, and sends the processed content of the movie to the DCD client.

11: The DCD client plays the movie using a built-in player or by calling a media player in the terminal.

In a second embodiment, a user sends to the subscription management module a user request for some contents on demand via the DCD client, and the dynamic content delivery procedure specifically includes.

1: The user interacts with the subscription management module via the DCD client to order a movie.

2: The subscription management module authenticates the user

3: After authenticating the user successfully, the subscription management module sends to the DCD management module the subscription information (e.g., a user identity and a content identity) obtained from the user request.

4: The DCD management module obtains original content (e.g., a movie file) and basic content information (e.g., a movie ID, movie file format, movie type and expiration time information) from an external content server according to the content identity. For example, the basic content information may include: the movie file format being mpeg, the movie type being action and the expiration time being 20051231.

5: The DCD management module initiates to the personalized dynamic content enabler a personalized processing request containing the user identity and the basic content information to request the personalized dynamic content enabler to generate a personalized processing policy of the content for the user, and may designate operation instructions (e.g., screen size, color depth and time period to be shielded) which must be included in the personalized processing policy.

6: The personalized dynamic content enabler informs the subscription management module of obtaining basic user static information and the DCD relevant information according to the user identity.

7: The subscription management module obtains the basic user static information (e.g., a user identity, age, sex, preference settings and terminal capability information) from a parameter server, obtains the DCD relevant information (e.g., subscription information, delivery schedule of subscription content, delivery processing policy and the content filtering options during roaming) from itself, which is maintained by itself. For example, the terminal capability information includes: the terminal type being LG660, the display capability being 160*128, 290 thousands color and supporting an avi format. The terminal capability information may be static or dynamic; when the mobile terminal supports “plug and play”, the terminal capability information is dynamic. The subscription management module returns the obtained information to the personalized dynamic content enabler.

8: The personalized dynamic content enabler obtains basic user dynamic information (e.g., location information and presence status information), for example obtains the user location from a location server and obtains the current user statues from a Presence Server.

9: The personalized dynamic content enabler generates the personalized processing policy for the content requested by the user. For example, if the current user status is “on driving”, the content can not be played temporarily; if the age of the user is 13, the content requested by the user will be reduced by the content of 15 minutes 20 seconds to 15 minutes 25 seconds. Content adaptation according to the terminal capability (e.g., supporting an avi file format) and the format of the original content (e.g., a mpeg file format) is necessary.

Before the personalized processing policy is generated, if the personalized dynamic content enabler determines that the basic user static information, the basic user dynamic information or the basic content information is in shortage, the personalized dynamic content enabler obtains the information being in shortage from a relevant module or an external server until the basic requirements necessary for generating the personalized processing policy is met.

After the personalized processing policy is generated, if the personalized dynamic content enabler determines that the personalized processing policy generated according to the above basic information can not meet user requirements, the personalized dynamic content enabler obtains other information from a relevant module or an external server, and regenerates a personalized processing policy according to the obtained information until the generated personalized processing policy meets the user requirements. In this process, the personalized dynamic content enabler compares the personalized processing policy with the user request and the predetermined judgment condition; if the personalized processing policy includes all contents of the user request and the judgment condition, it is determined that the personalized processing policy meets the user requirements. For example, the predetermined judgment condition designates that the personalized processing policy must include file format information, and the user request designates that the personalized processing policy must include screen size, color depth and the time period to be shielded. If the generated personalized processing policy includes: the file format: avi, the screen size: 160*128, the color depth: 65536, the time period to be shielded: 15 minutes 20 seconds to 15 minutes 25 seconds, the personalized processing policy meets the user requirements; if the generated personalized processing policy includes: the file format: avi, the screen size: 160*128, the time period to be shielded: 15 minutes 20 seconds to 15 minutes 25 seconds (the color depth designated by the user request is not included), or includes: the screen size: 160*128, the time period to be shielded: 15 minutes 20 seconds to 15 minutes 25 seconds (the file format designated by the predetermined judgment condition is not included), the personalized processing policy can not meet the user requirements.

10: After converting the personalized processing policy into a personalized operation instruction, the personalized dynamic content enabler sends it to the DCD management module. The personalized operation instruction at least includes the file format of the content to be processed, and may further include the information corresponding to the file format, such as screen size, color depth, data rate or the time period to be shielded or area.

11: The DCD management module processes the original content of the movie according to the personalized operation instruction, and sends the processed content of the movie to the DCD client.

12: The DCD client plays the movie using a built-in player or by calling a media player in the terminal.

In a third embodiment: a user sends to the DCD management module a user request for some on-demand contents via the DCD client, and the dynamic content delivery procedure specifically includes:

1: A user interacts with the DCD management module via the DCD client to order a movie.

2: The DCD management module requests the subscription management module to authenticate the user.

The subsequent processes are similar to processes 3 to 11 in the first embodiment.

In a fourth embodiment, a user sends to the DCD management module a user request for some contents on demand via the DCD client, and the dynamic content delivery procedure specifically includes:

1: A user interacts with the DCD management module via the DCD client to order a movie.

2: The DCD management module requests the subscription management module to authenticate the user.

The subsequent processes are similar to processes 3 to 12 in the second embodiment.

In a fifth embodiment: the server pushes to the user dynamic content subscribed by the user periodically according to user subscription information, and the dynamic content delivery procedure specifically includes:

1: The subscription management module triggers a dynamic content delivery service according to dynamic content delivery settings to which the user has subscribed, and the dynamic content delivery settings may include, but is not limited to, a content periodic delivery time required by the user.

2: The subscription management module authenticates the user.

The subsequent processes are similar to processes 3 to 11 in the first embodiment.

The sixth embodiment: the server pushes to the user dynamic content subscribed by the user periodically according to user subscription information, and the dynamic content delivery procedure specifically includes:

1: The subscription management module triggers a dynamic content delivery service according to dynamic content delivery settings to which the user has subscribed, and the dynamic content delivery settings may include, but is not limited to, a content periodic delivery time required by the user.

2: The subscription management module authenticates the user.

The subsequent processes are similar to processes 3 to 12 in the second embodiment.

The personalized processing request sent by the DCD management module to the personalized dynamic content enabler may only include a user identity or a content identity. If the personalized processing request only includes the user identity, the personalized dynamic content enabler obtains content identities of all contents to which the user has subscribed from the user subscription information via the subscription management module according to the user identity, obtains the relevant content information via the content identity, and respectively generates the personalized processing policies of the all contents for the user. The DCD management module processes the all contents to which the user has subscribed according to the personalized processing policies, and sends the processed contents to the DCD client of the user. If the personalized processing request only includes the content identity, the personalized dynamic content enabler obtains user identities of all users who have subscribed to the content from the user subscription information via the subscription management module according to the content identity, obtains the user information via the user identities, and respectively generates personalized processing policies of the content for the users. The DCD management module respectively processes the content requested by the users according to the personalized processing policies, and sends the processed content to the DCD client of each user who has subscribed to or requested the content.

To sum up, in the embodiments of the present invention, the dynamic content delivery system obtains partial basic information firstly; after generating a personalized processing policy according to the basic information, the dynamic content delivery system determines whether the personalized processing policy meets user requirements, obtains more information if the personalized processing policy can not meet the user requirements, and then generates a personalized processing policy according to the obtained information until the user requirements are met, and eventually sends the content to the user after the content is processed by means of the personalized processing policy. The embodiments of the present invention make it possible to reduce the cost of obtaining the information during the dynamic content personalized processing and improve the efficiency of delivering dynamic contents, thereby improving the service experience of the user.

Obviously, those skilled in the art may make numerous changes and variations on the solution of the present invention without departing from the spirit and scope thereof. Accordingly, it is intended that the present invention includes the changes and variations in case that such changes and variations come within the scope as set forth in the appended claims and the equivalent techniques thereof.

What is claimed is:

1. A method for dynamic content delivery, comprising:
generating a personalized processing policy for content subscribed or requested by a user according to user information and content information when delivering the content to the user; and
sending the content to a terminal of the user after processing the content by means of the personalized processing policy if the personalized processing policy meets user requirements.

2. The method of claim 1, further comprising:
querying whether the user information and the content information necessary for generating the personalized processing policy is in shortage;
obtaining the user information if the user information is in shortage;
obtaining the content information if the user information is in shortage.

3. The method of claim 1, further comprising:
determining whether the personalized processing policy meets the user requirements;
obtaining user information in shortage and content information in shortage necessary for generating a new personalized processing policy meeting the user requirements if the personalized processing policy does not meet the user requirements; and
regenerating the new personalized processing policy meeting the user requirements.

4. The method of claim 1, wherein the generating the personalized processing policy comprises:
receiving a dynamic content personalized processing request containing a user identity of the user;
obtaining at least one content identity corresponding to the user identity;
obtaining the content information corresponding to the at least one content identity; and
generating one personalized processing policy for the content corresponding to each of the at least one content identity.

5. The method of claim 1, wherein the generating the personalized processing policy comprises:
receiving a dynamic content personalized processing request containing a content identity;
obtaining at least one user identity corresponding to the content identity;
obtaining the user information corresponding to the at least one user identity; and
generating one personalized processing policy for one user corresponding to each of the at least one user identity.

6. The method of claim 3, wherein the determining whether the personalized processing policy meets the user requirements comprises:
comparing the personalized processing policy with a user request of the user for the content and a predetermined judgment condition; and
determining that the personalized processing policy meets the user requirement if the personalized processing policy includes all contents included in the user request and the predetermined judgment condition.

7. The method of claim 1, further comprising:
displaying the content subscribed or requested by the user on the terminal of the user through a built-in program or calling other local programs.

8. The method of claim 1, further comprising:
converting the personalized processing policy into a personalized operation instruction; and
processing the content according to the personalized operation instruction.

9. The method of claim 1, wherein the user information comprises basic user static information and basic user dynamic information.

10. A personalized dynamic content enabler, comprising:
an input module, capable of receiving a dynamic content personalized processing request, obtaining user information and content information according to the dynamic content personalized processing request;
a decision module, capable of generating a personalized processing policy for content subscribed or requested by a user according to the user information and the content information received from the input module.

11. The personalized dynamic content enabler of claim 10, further comprising:
a output module, capable of converting the personalized processing policy received from the decision module into a personalized operation instruction and outputting the personalized operation instruction.

12. The personalized dynamic content enabler of claim 10, wherein the decision module comprises:
a judgment sub-module, capable of deciding whether the user information and content information necessary for generating the personalized processing policy is in shortage; informing the input module to obtain the user information when deciding that the user information is in shortage and informing the input module to obtain the content information when deciding that the content information is in shortage;
a generating sub-module, capable of generating the personalized processing policy according to the user information and the content information if the judgment sub-module decides that the user information and the content information necessary for generating the personalized processing policy is not in shortage.

13. The personalized dynamic content enabler of claim 10, further comprising:
a decision judgment module, capable of deciding whether the personalized processing policy meets user requirements; if the personalized processing policy does not meet the user requirements, informing the input module to obtain user information in shortage and content information in shortage necessary for generating a new personalized processing policy meeting the user requirements.

14. The personalized dynamic content enabler of claim 13, wherein the decision judgment module compares the personalized processing policy with a user request of the user and a judgment condition predetermined in the decision judgment module, and delivers the personalized processing policy to the output module if the personalized processing policy includes all contents included in the user request and the judgment condition.

15. A system of dynamic content delivery, comprising:
a subscription management module, capable of authenticating a user subscribing to or requesting content, and providing user information;
a dynamic content delivery management module, capable of initiating a personalized processing request, providing the user information and content information necessary for generating a personalized processing policy, receiving a personalized processing policy, personalizing the content according to the personalized processing policy, and delivering the personalized content to a dynamic content delivery client of the user;
the personalized dynamic content enabler is capable of obtaining the user information from the subscription management module or the dynamic content delivery management module, obtaining the content information from the dynamic content delivery management module, generating the personalized processing policy according to the user information and the content information, and sending the personalized processing policy to the dynamic content delivery management module.

16. The system of claim 15, further comprising:
at least one parameter server connected with the subscription management module, capable of providing the subscription management module with the user information.

17. The system of claim 16, wherein the user information comprises at least one of public parameter settings information and terminal capability information of the user.

18. The system of claim 15, further comprising:
at least one content server connected with the dynamic content delivery management module, capable of providing the dynamic content delivery management module with original data of the content.

19. The system of claim 15, further comprising:
at least one attribute server connected with the personalized dynamic content enabler, capable of providing the personalized dynamic content enabler with the user information.

20. The system of claim 19, wherein the user information comprises at least one of location information and presence status information of the user.

21. The system of claim 15, wherein the personalized dynamic content enabler is further configured to decide whether the personalized processing policy meets user requirements; obtain user information in shortage and content information in shortage necessary for generating a new personalized processing policy meeting the user requirements if the personalized processing policy do not meet the user requirements; generate the new personalized processing policy.

22. The system of claim 21, wherein the personalized dynamic content enabler is further configured to convert the personalized processing policy into a personalized operation instruction and send the personalized operation instruction to the dynamic content delivery management module.
